(19) United States
(12) Patent Application Publication
(10) Pub. No.: US 2014/0212259 A1
(43) Pub. Date: Jul. 31, 2014

(54) Radiating Sprag Traction-Enhancing Attachment and Method for Flatbed Tow Vehicles

(71) Applicant: Jimmy W. Barnes, Lake George, NY (US)

(72) Inventor: Jimmy W. Barnes, Lake George, NY (US)

(21) Appl. No.: 14/250,849

(22) Filed: Apr. 11, 2014

(51) Int. Cl. B60T 3/00; B60P 1/04

(52) U.S. Cl. CPC B60T 3/00; B60P 1/04
USPC 414/813; 188/6

(57) ABSTRACT

An attachment apparatus and related method for enhancing traction during winching for a flatbed tow vehicle, comprising: a top planar surface; a bottom planar surface integrally-connected to the top planar surface at a fixed mating angle therebetween, wherein the fixed mating angle is substantially equal to a rear extremity angle between top and bottom surfaces of a rear extremity of a flatbed of the tow vehicle with which the apparatus is to be used; and a plurality of sprags permanently affixed to an underside of the bottom planar surface.

### BACKGROUND OF THE INVENTION

Flatbed tow vehicles such as the exemplary towing vehicle 12 illustrated by the left side plan view of in FIG. 1 have long been used to transport disabled and/or immobilized vehicles. With both the towing vehicle 12 and a disabled or immobilized vehicle (not shown) on a ground and/or roadway (“underlying terrain”) designated by 11, the basic method for mounting the disabled or immobilized vehicle atop a flatbed 14 is well known: The towing vehicle 12 which includes flatbed 14 is first situated in front of the disabled or immobilized vehicle. Then, the flatbed 14 itself is actuated in a well-known manner along the arrow 13 to be moved rearward and concurrently tilted such that its rear extremity 1 comes into contact with the underlying terrain 11 directly in front of the disabled or immobilized vehicle. In other words, the flatbed rear extremity 1 is moved substantially along arrow 13 from the relative locale designated as “A” to that designated as “B,” with locale “B” being directly in front of the disabled or immobilized vehicle.

FIG. 2 magnifies the rear flatbed extremity 1 in these two positions “A” and “B.” Referring to FIG. 2, we shall refer to configuration “A” as a “driving configuration” because that is how the flatbed towing vehicle 12 is configured when it is driving, and configuration “B” as a “mounting configuration” because that is how the towing vehicle 12 is configured while a disabled vehicle is being mounted atop the flatbed 14. It should be noted as highlighted in FIG. 2 configuration “A,” that the rear extremity 1 of flatbed 14 has top 21 and bottom 22 surfaces which are angled relative to one another by an acute rear extremity angle designated as 23. This angling is a customary feature of nearly all flatbeds, and has a simple rationale: the top surface 21 is simply the trailing end of the top surface of the entire flatbed 14 and so is flush with the rest of the flatbed 14. But when moved into the mounting configuration “B” including the tilting of the flatbed 14, it is desired for the bottom surface 22 to become substantially flush with the underlying terrain 11. The rear extremity angle 23 achieves this by being substantially equal to the angle through which the flatbed 14 is tilted when it is moved from the driving configuration “A” to the mounting configuration “B.” The invention disclosed here will take advantage of this customary rear angling 23. Typically, this rear extremity angle 23 is approximately fifteen (15) degrees or slightly less.

Once in the mounting configuration “B,” to start the process for mounting the disabled or immobilized vehicle atop the flatbed 14, a winch system (not shown) is attached between the towing vehicle 12 and the disabled or immobilized vehicle. The winching system is tightened so as to be drawn in a forward direction so as to roll the disabled or immobilized vehicle forward onto the flatbed 14. Then, once the disabled or immobilized vehicle has been rolled forward onto the flatbed 14, the flatbed 14 with the disabled or immobilized vehicle atop the flatbed 14 is reverse-actuated and returned from position “B” to position “A.” The disabled or immobilized vehicle is then secured in place atop flatbed 14 so that the towing vehicle 12 in driving configuration “A” can thereafter be driven elsewhere (for example, to a repair shop) while carrying the disabled or immobilized vehicle.

It will be appreciated, and is certainly well-known to tow vehicle drivers and motorists alike, that in wet or icy conditions, and/or if the disabled or immobilized vehicle is in a ditch or on some other slanted or relatively inaccessible section of earth, the underlying terrain 11 which in FIG. 1 is illustrated to be flat and unencumbered, may in fact itself present its own challenges to moving the disabled or immobilized vehicle onto the flatbed 14, including but not limited to difficulty gaining sufficient traction during the winching operation. The purpose of this invention is to help overcome such challenges.

FIG. 2 in the mounting configuration “B” illustrates this fairly clearly. Once the winching system has been attached between the towing vehicle 12 and the disabled or immobilized vehicle, and as the winch is tightened, the relative force between the towing vehicle 12 and the disabled or immobilized vehicle will of course pull the disabled or immobilized vehicle forward. But, there will be an equal and opposite force pulling the towing vehicle 12 backward. If tires 15 of the towing vehicle 12 have sufficient traction with the underlying terrain 11, then there will not be any problem, because these will overcome any such backward pull on the towing vehicle 12. However, if the underlying terrain 11 is wet and slick, or snowy or icy or muddy, or if the underlying terrain 11 is not level such that the towing vehicle 12 not only needs to pull the disabled or immobilized vehicle laterally forward but also needs to lift the latter vehicle with a vertical component of movement against the pull of gravity—such as when the latter vehicle is in a ditch or on a badly-slanted section of terrain—the towing vehicle tires 15 may not, by themselves, provide all of the required traction to successfully complete the winching and mounting of the disabled or immobilized vehicle.

In such circumstances, it is desirable to provide a traction-enhancing attachment 3 first shown in FIG. 3 for introducing additional torque-balanced traction to the flatbed towing vehicle 12 in a manner that is safe, fast, simple, effective and inexpensive. It is further desirable for this attachment 3 to be configured such that it can be retrofitted to a preexisting flatbed towing vehicle 12 quickly and easily when needed to enhance traction, and not used when not needed. In other words, it is desirable to be able to use or not use this attachment at will, depending on whether or not there is a present need for added traction. And, because the mounting locale “B” is the particular locale at which the addition of traction can be most effective because that is where the winching forces are most focused, it is desirable to provide a traction-enhancing attachment which mates with the rear extremity 1 of the flatbed 14 right at the location where the extra traction can be most effective.

Braking devices designed to slow and stop vehicles when moving, and to prevent vehicles from moving once they are stopped, are of course well-known and widely used in the relevant arts. It is also generally known that ground-engaging sprag brakes, such as those in class 188, subclass 6 of the US Patent Classification system, can be used to securely immobilize a vehicle in a set location by adding traction between the vehicle and the underlying terrain upon which the vehicle is situated.

An information disclosure being filed with this patent application contains a number of inventions of general background interest in relation to the invention disclosed here. But it will be appreciated upon a review of this prior art that sprag brakes—in those circumstances where they are employed—are very often an integral component of the vehicle or other device which it is desired to have immobilized, rather than being attachments which can add traction circumstantially, at will, on an as-needed and where-needed basis.

Specifically, what does not appear to be disclosed, suggested or motivated by any of the prior art, are separate traction-enhancing sprag brake devices which are easily attached to a preexisting vehicle to enhance traction only when and where needed, and which can be removed at will once they are no longer needed. Nor do there appear to be any prior art devices specifically designed to attach to flatbed tow vehicles, at will, in the precise location or locations which, in the judgment of the tow operator, are best suited to add non-torqueing traction to the tow-vehicle during winching of a disabled or immobilized vehicle onto the flatbed.

Such a traction-enhancing attachment for introducing additional traction to a flatbed towing vehicle in a manner that is safe, fast, simple, effective and inexpensive, and that can be employed or not employed at will in the judgment of the tow operator depending on particular circumstance, and that can be situated to provide traction at the precise position or positions best suited to any given winching circumstance also based on operator judgment, does not appear to be disclosed, suggested or motivated anywhere in the prior art.

### SUMMARY OF THE INVENTION

Disclosed herein is an attachment apparatus and related method for enhancing traction during winching for a flatbed tow vehicle, comprising: a top planar surface; a bottom planar surface integrally-connected to the top planar surface at a fixed mating angle therebetween, wherein the fixed mating angle is substantially equal to a rear extremity angle between top and bottom surfaces of a rear extremity of a flatbed of the tow vehicle with which the apparatus is to be used; and a plurality of sprags permanently affixed to an underside of the bottom planar surface.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 is a left side plan view illustrating an exemplary flatbed towing vehicle in accordance with prior art practice, as well as the manner in which the flatbed of such vehicle is actuated for mounting a disabled or immobilized vehicle (not shown) atop the flatbed.

FIG. 2 magnifies the rear extremity of the flatbed in both a forward driving configuration “A” and a rearward mounting configuration “B.”

FIG. 3 is a left side plan view illustrating a radiating sprag traction-enhancing attachment in a preferred embodiment of the invention.

FIG. 4 is a bottom plan view illustrating the radiating sprag traction-enhancing attachment in the FIG. 3 preferred embodiment of the invention.

FIG. 5 is a left side perspective view of one of the three sprags in the preferred embodiment of FIGS. 3 and 4.

FIG. 6 is a left side plan view illustrating the method by which the radiating sprag traction-enhancing attachment of the preferred embodiment is attached to a flatbed in preparation for use, with the flatbed in driving configuration “A.”

FIG. 7 is a left side plan view illustrating the radiating sprag traction-enhancing attachment of the preferred embodiment after it has been attached to a flatbed in preparation for use, but before the flatbed has been actuated from the driving configuration “A” to the mounting configuration “B.”

FIG. 8 is a left side plan view illustrating the radiating sprag traction-enhancing attachment of the preferred embodiment in use, wherein the flatbed is in the mounting configuration “B” and the sprags have become dug into the underlying terrain to add traction precisely at the key point or points of contact where the flatbed meets the terrain.

FIG. 9 is a bottom plan view illustrating the radiating sprag traction-enhancing attachment of the preferred embodiment while it is attached to a flatbed for use.

FIG. 10 is a bottom plan view illustrating an alternative use embodiment, in which more than one radiating sprag traction-enhancing attachment of the preferred embodiment is attached to a flatbed for use.

FIG. 11 is a bottom plan view illustrating a radiating sprag traction-enhancing attachment in an alternate preferred embodiment of the invention employing a plurality of sprag sets.

FIG. 12 is a left side plan view illustrating the preferred embodiment of the invention as in FIG. 3, but with an optional attachment removal feature for aiding the removal of the radiating sprag traction-enhancing attachment from the flatbed after it has been used, as well as with an optional locking hinge for varying a fixed mating angle between the top and bottom surfaces of radiating sprag traction-enhancing attachment to accommodate any variations in flatbeds from one type or model of towing vehicle to the next.

FIG. 13 is a top plan view illustrating the FIG. 12 alternate preferred embodiment of the invention.

### DETAILED DESCRIPTION

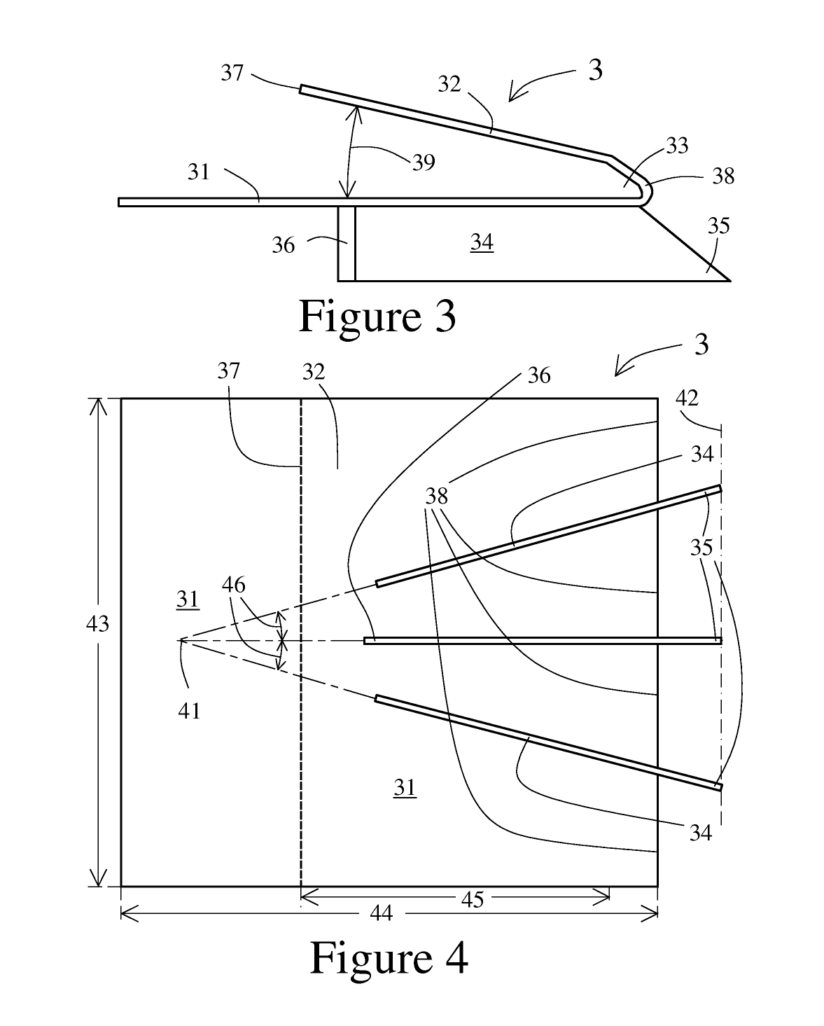

FIGS. 3 and 4, which should be viewed together as projecting different views of the same apparatus, respectively illustrate a radiating sprag traction-enhancing attachment 3 in a preferred embodiment of the invention from left side and bottom views respectively. The “left” side is defined based on FIG. 1 which shows the left side (driver's side in the United States and most other countries) of the towing vehicle 12. Because attachment 3 is configured to mate and attach to the rear flatbed extremity 1, its own left side is thus defined based on an orientation in which its attachment to the towing vehicle 12 is viewed from the left side of the towing vehicle. That is, “left” and “right” throughout this disclosure are defined based on the left and right side of the towing vehicle 12 and those definitions follow suit with regard to the orientation of attachment 3 when said attachment is attached to towing vehicle 12. Once left and right are defined in this way, so too are “top” and “bottom” and “front” and “back” defined in relation to the towing vehicle 12 and then carried forward to the attachment 3 as it becomes oriented when attached to the towing vehicle 12.

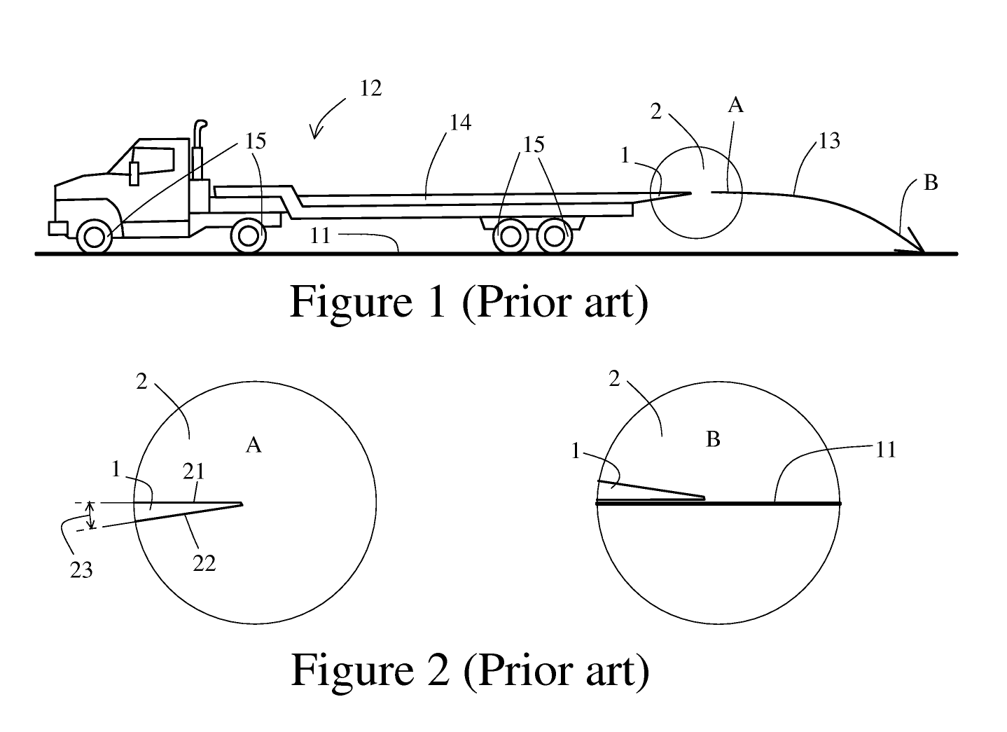

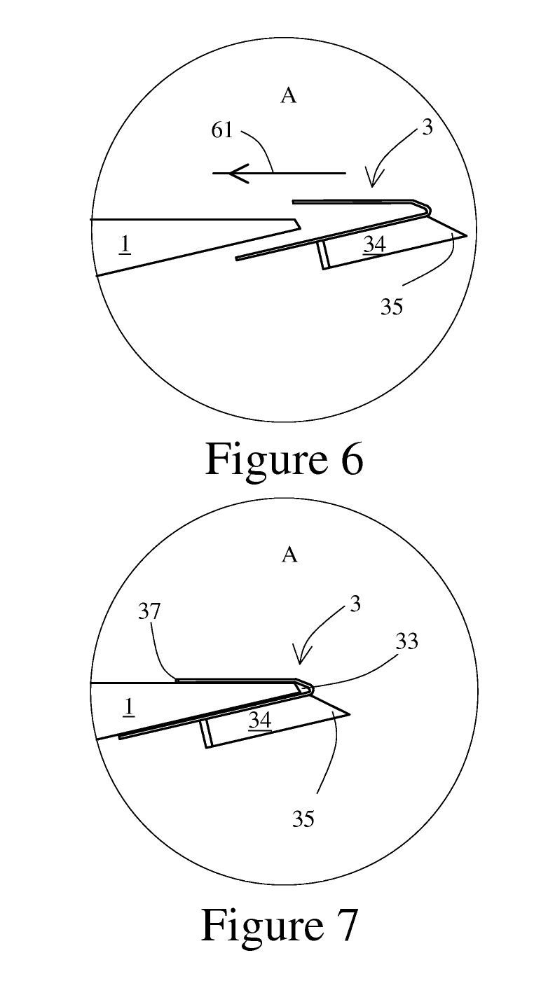

Referring to FIGS. 3 and 4, the radiating sprag traction-enhancing attachment 3 comprises a bottom planar surface 31 and a top planer surface 32 which are integrally fabricated at a fixed mating angle 39 relative to one another, via a top-to-bottom connection surface 38. This fixed mating angle 39, by design, is fabricated to be substantially equal to the rear extremity angle 23 between the top 21 and bottom 22 surfaces of the rear extremity 1 of flatbed 14, see FIG. 2, configuration “A.” This concurrence between the angles 39 and 23 will be appreciated by comparing FIG. 3 with FIGS. 6, 7 and 8.

It will also be seen that bottom planar surface 31 is somewhat longer from front to back that top planer surface 32, i.e., that bottom planar surface 31 extends somewhat further to the left of FIGS. 3 and 4 than does top planer surface 32. Labeling the forward extremity 37 of top planer surface 32, the hidden line 37 in FIG. 4 represents this forward extremity 37 of top planer surface 32, whereby top planer surface 32 is labelled but hidden from view in the bottom plan view of FIG. 4.

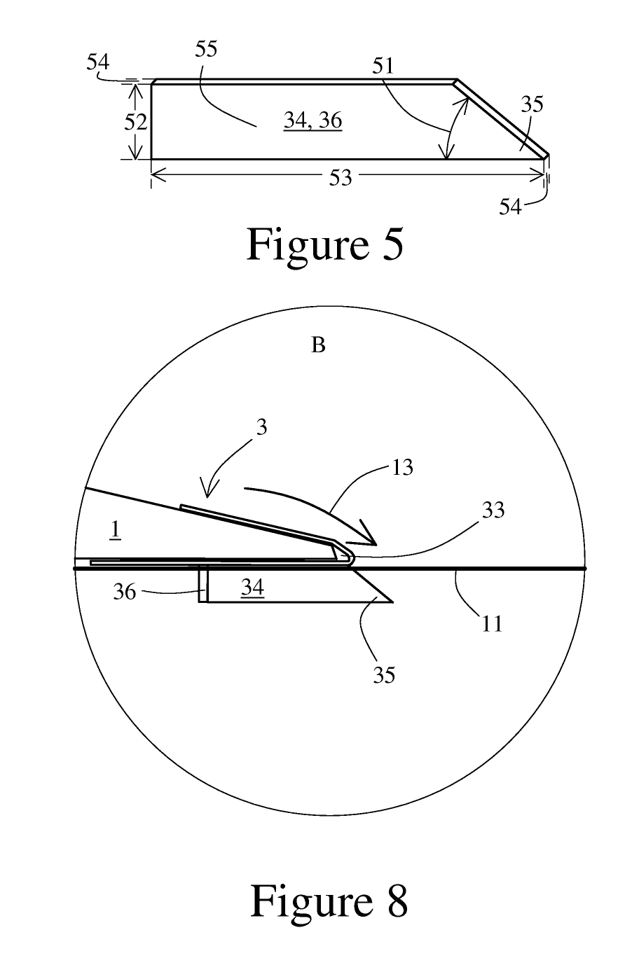

Traction-enhancing attachment 3 further comprises a radiating 41 plurality of sprags 34, 36 integrally fabricated upon and permanently affixed to the underside of bottom planar surface 31, as illustrated in FIGS. 3 and 4. Each such sprag 34, 36 comprises a sprag tip 35 at its rear extremity which is acutely-angled 51 as shown, see also FIG. 5. This acute angle 51 of the sprag tips 35 when pressed backward against an underlying terrain 11 during the winching operation facilitates “biting” and penetration of the attachment 3 and consequently the flatbed 14 into the underlying terrain 11 to establish enhanced traction, as will be seen most clearly in FIG. 8.

It is preferred for best traction results, but not required, that this plurality of sprags will consist of exactly three (3) sprags, which is why three such sprags, namely a pair of outer sprags 34 and a center sprag 36, are illustrated in the preferred embodiment. But it is optional, and regarded to be within the scope of this disclosure and the associated claims, to have as few as two sprags, and as many as four, five, six, seven, eight or nine sprags.

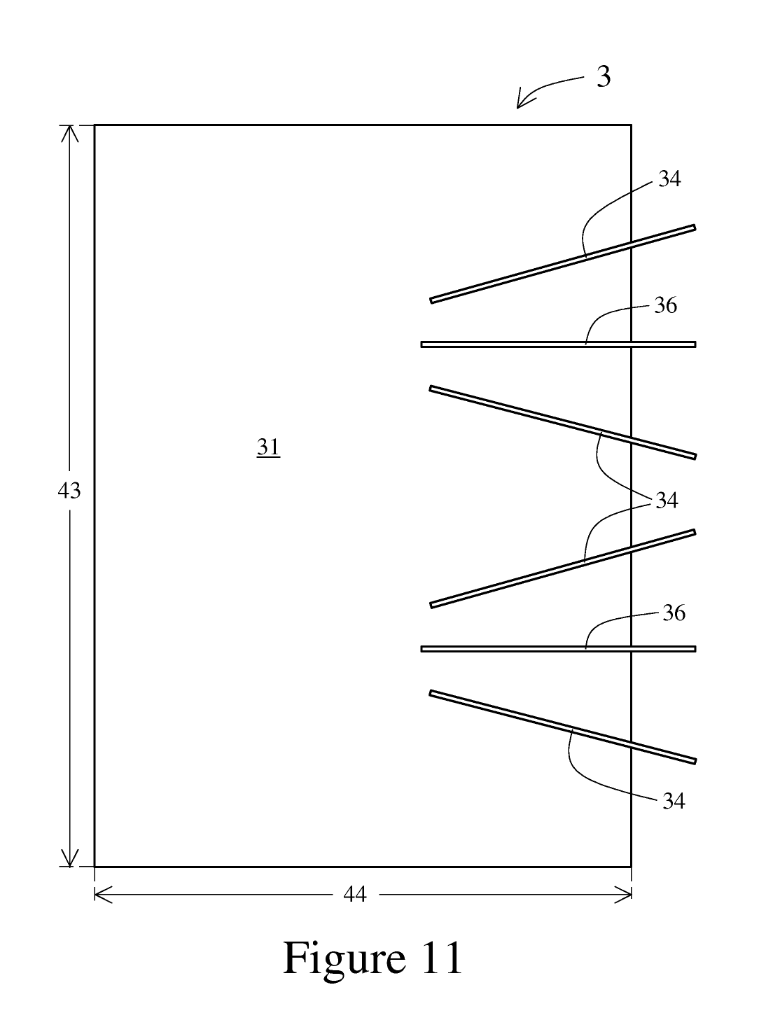

In all cases, it is highly-preferred that these sprags 34, 36 be radiating, which is to say, that when viewed from the bottom of attachment 3 as shown in FIG. 4, geometric lines extended from the sprags 34, 36 will substantially intersect at the geometric point designated by 41. Thus, it is said that the outer 34 and inner 36 sprags are “radiating” outwardly substantially from a common geometric point 41. It will be seen that each of the three sprags illustrated in FIG. 4 is disposed in relation to the next-adjacent sprag by a non-zero sprag radiation angle 46 of approximately 15 degrees between adjacent sprags. However, this sprag radiation angle 46 can be as small as 5 degrees and as large as 45 degrees including approximately 5, 10, 15, 20, 25, 30, 35, 40 and 45 degrees and continuous variations over the range from 5 to 45 degrees. It will also be appreciated that the sprag radiation angle 46 for any particular variation of the preferred embodiment will also depend upon the precise number of the plurality of sprags 34, 36, which in the illustrations is equal to three, but which as noted above can be anywhere from two to nine sprags. For a larger number of sprags, the next-adjacent sprag radiation angle 46 will of course need to be smaller, and for a small number of sprags, for example, two sprags, the angle 46 will be larger, for example, 30 degrees. It is also regarded to be within the scope of this disclosure and its associated claims that there might be two or more sets of sprags, for example, in a two-sprag-set configuration variation of the preferred embodiment as is illustrated by FIG. 11, which is the same as FIG. 4 but for its having two sets of sprags as well as a relatively larger side-to-side dimension as referenced by the dimensional line 43.

As is also illustrated in FIG. 4, it is preferred for best traction results, that traction-enhancing attachment 3 is fabricated such that all of the sprag tips 35 are collinear in relation to the rear of attachment 3, as illustrated by the substantial alignment of sprag tips 35 along the geometric line 42 in FIG. 4.

FIG. 5 illustrates any of the three sprags 34, 36 of FIGS. 3 and 4, when viewed from the left side as defined earlier, with some perspective of depth. As stated earlier, the sprag tips 35 at the rear extremity of each sprag 34, 36 are acutely angled 51. In the illustration of FIGS. 3 and 5 to 8, this acute sprag tip angle referenced as 51 in FIG. 5 is shown to be approximately 40 degrees, though any acute angle 51 from 10 degrees to 89 degrees is acceptable in accordance with preferred embodiment variations of the invention, including 10, 15, 20, 25, 30, 35, 40, 45, 50, 55, 60, 65, 70, 75, 80, 85 and 89 degrees, as well as continuous variations over the range from 10 to 89 degrees. Each sprag has an elongated front-to-rear length 53 from its front to the rear tip 35 of anywhere from 3 inches to 10 inches, which is substantially exceeds its height 52. In this illustration, the sprag length 53 exceeds the sprag height 52 by a factor of about 5 to 1, and in general this ratio may be anywhere along the continuous spectrum from 2:1 to 8:1 inclusive, including approximately 3:1, 4:1, 5:1, 6:1 and 7:1. And each sprag has a left-to-right (as defined by side of the tow vehicle 12) depth 54 which is very much smaller than either sprag length 53 or sprag height 52. Indeed, commensurate with a plate thickness of about ¼ inch to ½ inch inclusive for all of the metal/steel, etc. plates comprising attachment 3 as will be momentarily discussed, the sprag depth 54 also comprises a plate thickness of about ¼ inch to ½ inch inclusive.

Preferably, for ease of manufacture, each sprag is manufactured substantially like every other sprag. Thus, for example, for the preferred three-sprag embodiment of the invention, one would manufacture three like-sprags, then permanently affix them to the underside of bottom planar surface 31 in the radiating 41 configuration shown in FIG. 4. When comparing FIG. 4 with FIG. 3, it will be noted that when viewed from the left side as in FIG. 3, center sprag 36 will be seen to slightly protrude beyond the left outer sprag 34. This protrusion will occur when in fact a) all of the sprags 34, 36 are like-manufactured as is preferred, b) all of the sprag tips 35 are collinear 42 as is preferred, and c) the sprags 34, 36 are radiating 41 as is highly-preferred.

Because traction-enhancing attachment 3 will be subjected to very large forces up to 8 to 12 tons when used to add winching traction between a towing the towing vehicle 12 and a disabled or immobilized vehicle when the latter is to be mounted for towing, it will be appreciated that all of the aforementioned components of attachment 3 are to be fabricated from a strong, rigid, heavy metal or steel (e.g., cold steel) or iron or alloy or combination thereof. It will further be appreciated that the integral fabrication/permanent affixation of the sprags 34, 36 upon and to the underside of bottom planar surface 31 is to be achieved by a very strong attachment method such as but not limited to high-strength welding, or unitary casting through a molding process in which the metal or steel or iron or alloy or combination thereof is melted at very high temperature and then poured into a mold and left to cool as a unitary cast into the traction-enhancing attachment 3 comprising all of the aforementioned surfaces and sprags in the aforementioned configurations.

Referring to FIG. 4, in a preferred, exemplary embodiment, bottom planar surface 31 is approximately 10 inches from side to side along the dimensional line 43, by 10 inches from front to back along the dimensional line labelled as 44. Top planer surface 32 is similarly about ten inches from side to side along 43, and, when accounting for the fixed mating angle 39, projects approximately six inches from front to back along the dimensional line labelled as 45. Other dimensions are substantially proportionate to what is shown in FIGS. 3 and 4, which is to say, FIGS. 3 and 4 are substantially drawn to scale. This includes a ¼ inch to ½ inch thickness for all of the metal/steel, etc. plates. While these are preferred dimensions, they are in no way limiting. They represent a balance of size and weight versus traction strength and effectiveness.

Specifically, given that attachment 3 is fabricated from a strong, rigid, heavy metal or steel or iron or alloy or combination thereof, if the dimensions were to be too large, attachment 3 would become too heavy to be carried and moved without burden to the operator of the towing vehicle 12. For example, when fabricated from cold steel at the aforementioned dimensions, the overall attachment 3 weighs about 15 to 20 pounds. So it will be appreciated that if, for example, all liner dimensions were to be doubled (i.e., if bottom planar surface 31 bottom planar surface 31 were to be 20″×20″ and all else was to scale accordingly), the weight would be quadrupled to be from 60 to 80 pounds which would become too burdensome. At the same time, given that attachment 3 is used to add traction to a winching operation rated at up to 8 to 12 tons, attachment 3 must be large enough to be effective. In experimental practice, it has been determined that the dimensions set forth above provide a good balance between size and weight on the one hand, and utilitarian effectiveness on the other.

The final point to be made as regards traction-enhancing attachment 3 itself as an apparatus, before we examine its method of use, is that the aforementioned configuration of attachment 3 is also preferably designed so as leave a small mating clearance 33 referenced in FIG. 3. This mating clearance 33 is used to facilitate a tight mating between attachment 3 and the rear extremity 1 of flatbed 14, as will be better appreciated as we now turn to examine the method by which traction-enhancing attachment 3 is used.

As discussed earlier, the fixed mating angle 39 referenced in FIG. 3, by design, is fabricated to be substantially equal to the rear extremity angle 23 between the top 21 and bottom 22 surfaces of the rear extremity 1 of flatbed 14, see FIG. 2, configuration “A.” And, as just discussed, attachment 3 is also preferably designed so as leave the small mating clearance 33 which is also referenced in FIG. 3. Keeping this in mind, we now turn to FIGS. 6 and 7.

When a towing vehicle 12 has arrived at the site of a disabled and/or immobilized vehicle which needs to be towed on the flatbed, the tow operator will of course assess the situation including the underlying terrain 11 and decide whether or not the tires 15 of the towing vehicle 12 can gain sufficient traction against the underlying terrain 11 without using traction-enhancing attachment 3. If attachment 3 is not needed, then it is not used. But if the operator concludes that additional traction is required because, for example not limitation, the underlying terrain 11 is wet and slick, or snowy or icy or muddy, or the underlying terrain 11 is not sufficiently level and additional traction is needed not only for a lateral but also for a vertical component of pull against gravity, or any combination of these challenges, then the operator will use the traction-enhancing attachment 3. In the discussion to follow, we shall regard underlying terrain 11 to be a poor traction terrain, such as snow, ice, dirt, or mud, and not simply clean roadway pavement which does require added traction to facilitate a successful winch operation.

So referring to FIG. 6, with the flatbed 14 in driving configuration “A,” the tow operator first lifts traction-enhancing attachment 3 and orients it into alignment with the rear extremity 1 of flatbed 14, in particular, by aligning the fixed mating angle 39 with the substantially-equal rear extremity angle 23, and with the sprags 34 on the underside facing downward, as illustrated. Then, the operator will move attachment 3 in the direction shown by arrow 61 so as to mate with the rear extremity 1 of flatbed 14 and arrive at the mated configuration of FIG. 7.

We now see in FIG. 7 that the small mating clearance 33 is designed to leave a little bit of space to facilitate a tight mating between attachment 3 and rear extremity 1. Particularly, once attachment 3 is placed over rear extremity 1 as shown in FIG. 7, the operator may bang attachment 3 proximate 33 in a forward direction (to the left in FIG. 7) either by hand or with a hammer, to tighten the mating between attachment 3 and rear extremity 1. It will be appreciated that the mating clearance 33 provides a space such that any sort of bang upon attachment 3 proximate 33 in direction 61 of FIG. 6 will cause a tighter frictional mate between attachment 3 and rear extremity 1. The purpose of this tightening is to ensure that attachment 3 will not slip off of rear extremity 1 once the flatbed 14 is tilted, which is the next step.

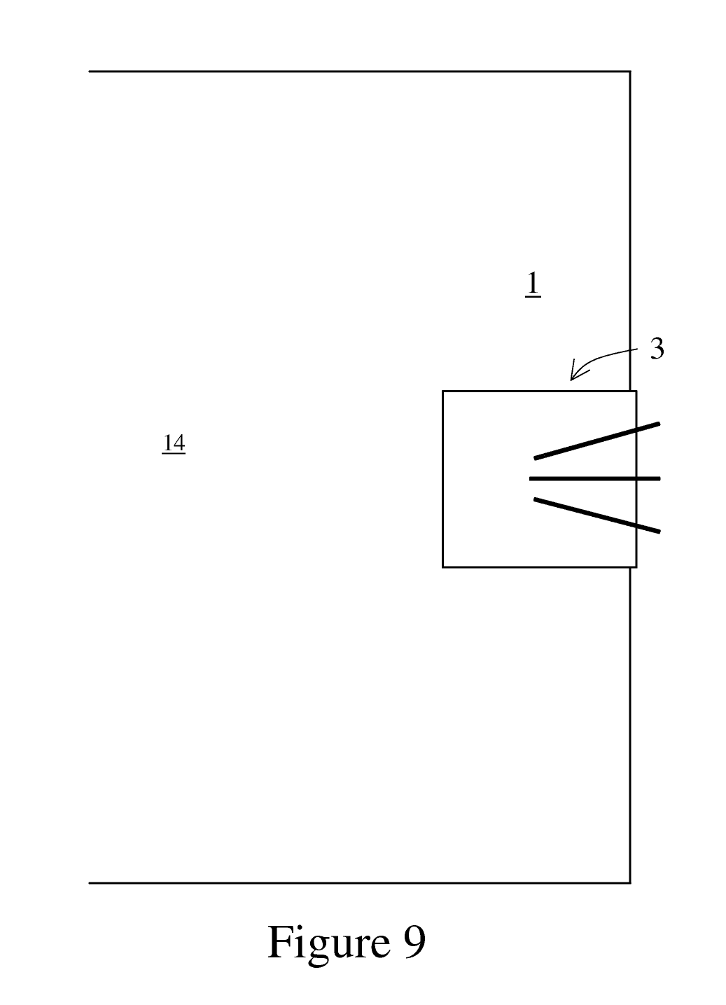

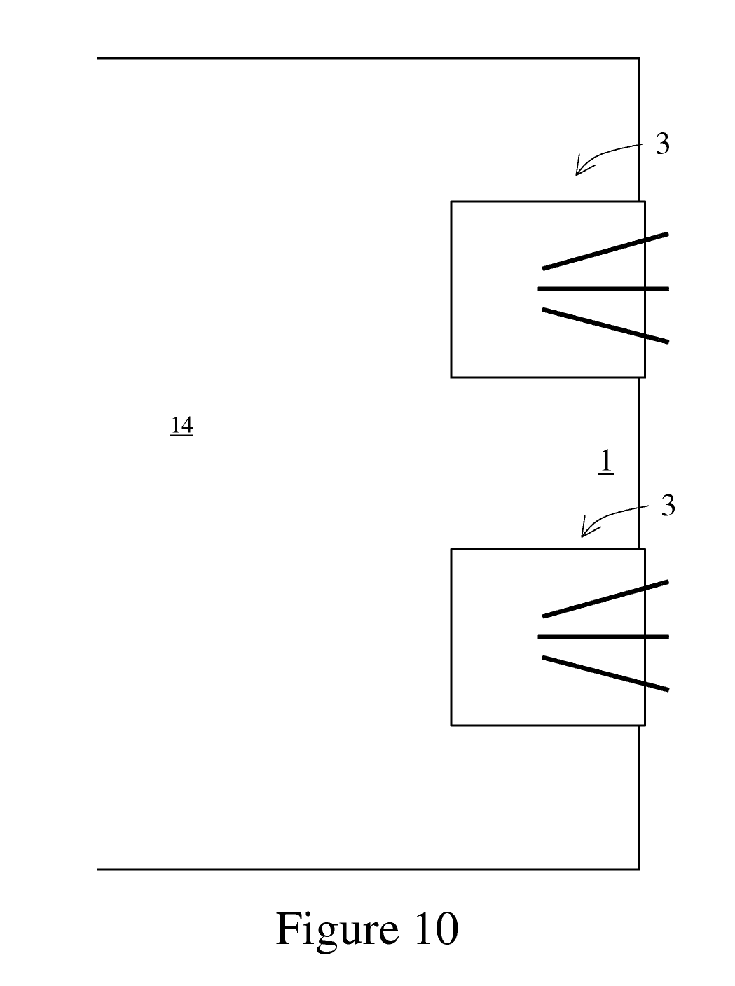

FIG. 9 is a bottom view of the radiating sprag traction-enhancing attachment 1 of the preferred embodiment while it is attached to the rear extremity 1 of flatbed 14, and is essentially a bottom view of all of the left-side views of FIGS. 7 and 8. There is no vertical line on the left of FIG. 9 because this shows only the rear portion of the flatbed 14, while the entire flatbed extends much further to the left in FIG. 9. The same is true for FIG. 10. The point to be made by FIG. 9 is simply that it is preferred to attach attachment 1 to the rear extremity 1 of flatbed 14 in a position that is substantially left-right centered on the flatbed 14, which is in the middle of FIG. 9 relative to its top and bottom. As discussed further below, this maximizes traction and avoids any torqueing during the winch operation, but may be varied by the operator depending upon the situation of any particular towing job.

Now, once traction-enhancing attachment 3 is mated and tightened with rear extremity 1 of flatbed 14 as shown in FIG. 7, the flatbed 14 is actuated 13 in the usual and customary manner as earlier described in connection with FIGS. 1 and 2. In particular, flatbed 14 is actuated along the arrow 13 so as to be moved rearward and concurrently tilted such that its rear extremity 1 comes into contact with the underlying terrain 11 directly in front of the disabled or immobilized vehicle, that is, from the relative locale designated as “A” to that designated as “B” in FIGS. 1 and 2 with locale “B” being directly in front of the disabled or immobilized vehicle.

Now, however, in contrast to prior art practice, traction-enhancing attachment 3 is already attached to rear extremity 1 of flatbed 14 while the flatbed 14 is actuated 13. Thus, as illustrated in FIG. 8, following the rearward, downward, tilting actuation 13, and as a natural and inherent consequence thereof, the radiating 41 plurality of sprags 34, led by sprag tips 35, will penetrate into and below the underlying poor traction terrain 11, i.e., will penetrate into and below the snow, ice, dirt, mud, etc. that is represented by the surface 11.

Specifically, it will be appreciated by studying FIG. 8 as well as FIG. 4 that there are two aspects of traction-enhancing attachment 3 which, in the configuration of FIG. 8, will substantially enhance traction between the rear extremity 1 of flatbed 14 and the poor traction terrain 11. First, as seen in FIG. 8 from the left side view, the acute angling of sprag tips 35 will cause the sprags to dig in to underlying terrain 11 and establish traction so as to substantially bar the rear extremity 1 of flatbed 14 from sliding backwards during the winch operation. Second, as seen in FIG. 4 from the bottom view, the radiating 41 configuration of the sprags 34, 36, and in particular the angling of each sprag by a sprag radiation angle 46 relative to its next adjacent sprag in a sort of “plow” or “funnel” or “wedge” configuration will case a further “bite” of resistance between the rear extremity 1 of flatbed 14 and the underlying terrain 11 so as to additionally bar the rear extremity 1 of flatbed 14 from sliding backwards during the winch operation, by wedging the faces 55 of the sprags 34, 36 against the underlying terrain 11.

Furthermore, it will be appreciated that because traction-enhancing attachment 3 is substantially centered in relation to the flatbed 14 as seen in FIG. 9, the extra traction is introduced directly where it is most needed and most effective, often, centered at the rear extremity 1 of flatbed 14. Because of this centering, there will be minimal torqueing of the flatbed 14 during winching as would otherwise occur were the attachment 3 not substantially centered. In individual situations with an unusual terrain or positioning of the vehicles, the necessary winching operation may, in the judgment of the operator, require attachment 3 to be mounted other than at the center of rear extremity 1 to avert torqueing. The ability for the operator to choose the most-effective, minimized-torqueing location(s) to mount attachment 3 on rear extremity 1 is one of the advantages of this invention.

FIG. 10 is a variation on the use of traction-enhancing attachment 3 as just described in FIG. 9. Here we simply see two traction-enhancing attachments 3 rather than one, attached to the rear extremity 1 of flatbed 14. In contrast to FIG. 9, these are mounted in a balanced configuration relative to the flatbed 14 so that the traction enhancement is still substantially centered to avert torqueing, but is now distributed in a balanced way at two positions along the rear extremity 1 of flatbed 14. Again, optimum placement to minimize torqueing may vary for particular unusually-configured winch operations.

As just discussed, it will be apparent to someone of ordinary skill and is within the scope of this disclosure and its associated claims, that the optional use of two or more traction-enhancing attachments 3 may be desirable for especially-difficult winching operations. It will be further apparent and within the scope of this disclosure and its claims that the exact locale(s) along flatbed 14 for placing one or more traction-enhancing attachments 3 along the rear extremity 1 of flatbed 14, and the decision as to how many such attachments 3 to in fact use, will ultimately be a matter of the tow operator exercising professional judgment as to the optimum attachment 3 placement to facilitate winching for any given tow, given the wide variety of situations under which vehicles become immobilized and/or disabled and so require extraction through winching onto a flatbed, as well as the wide variation in sizes and shapes and weights of vehicles that encounter unfortunate circumstances which require flatbed towing.

FIG. 11 is a bottom plan view illustrating a radiating sprag traction-enhancing attachment 3 in an alternate preferred embodiment of the invention. This embodiment employs two sprag sets as illustrated. Each sprag set comprises a plurality of sprags 34, 36 with a non-zero sprag radiation angle 46 (see FIG. 4) between adjacent sprags within any given set, such that the sprags within that set radiate outwardly substantially from a common geometric point (see 41 in FIG. 4) for that set. Not dissimilarly to what was discussed in FIG. 10, this provides a wider girth for traction, and consequently, when properly positioned by the operator along the rear extremity 1 of flatbed 14, will avert undesirable torqueing during the winch operation.

Based on all of the foregoing, it will be appreciated that the number of sprags per attachment 3, the number of sprag sets per attachment 3, and the number of attachments 3 used for any particular winch operation can all be individually or collectively varied within the scope of this disclosure and its associated claims.

Returning to FIG. 8, once at least one traction-enhancing attachment 3 has been attached to rear extremity 1 of flatbed 14 in a balanced manner in accordance with the professional judgment of the tow operator and “bitten” into the underlying terrain 11, the winch operation is commenced. With the flatbed in the “B” configuration of FIGS. 1 and 2 and with the traction-enhancing attachment(s) 3 “biting” the underlying terrain 11 as in FIG. 8, very substantial traction beyond that of the tires 15 will be added directly at the rear extremity 1 in the precise optimal position(s) needed for a successful winch. Again, the radiating 41 configuration of the sprags 34 creates what may be thought of as a “plow” or “funnel” or “wedge” which adds traction against flatbed 14 moving backwards during winching. The disabled/immobilized vehicle is then winched onto the flatbed 14 in conventional manner, but with this added traction at the base of the flatbed 14 rear extremity 1. The flatbed 14 is then returned from configuration “B” to configuration “A” in conventional manner, and once that is done and the disabled/immobilized vehicle is secured to the flatbed 14 for transport, the towing vehicle 12 can drive the disabled/immobilized vehicle to wherever it is to be towed.

The final step before towing vehicle 12 drives off with the disabled/immobilized vehicle, is to detach the attachment(s) 3 from the rear extremity 1 of flatbed 14. Because the large forces from the winch operation, measured in tons, will in all likelihood cause the attachment(s) 3 to be even more-tightly attached to the rear extremity 1 than it was prior to the actuation of the flatbed into configuration “B” and subsequent winching, it may be necessary to use a hammer or similar auxiliary device to apply a rearward-oriented impulse to attachment(s) 3 along the forward extremity 37 of top planer surface 32 to dislodge attachment(s) 3 from the rear extremity 1 of flatbed 14 so attachment(s) 3 can then be stowed for the next time attachment(s) 3 are needed.

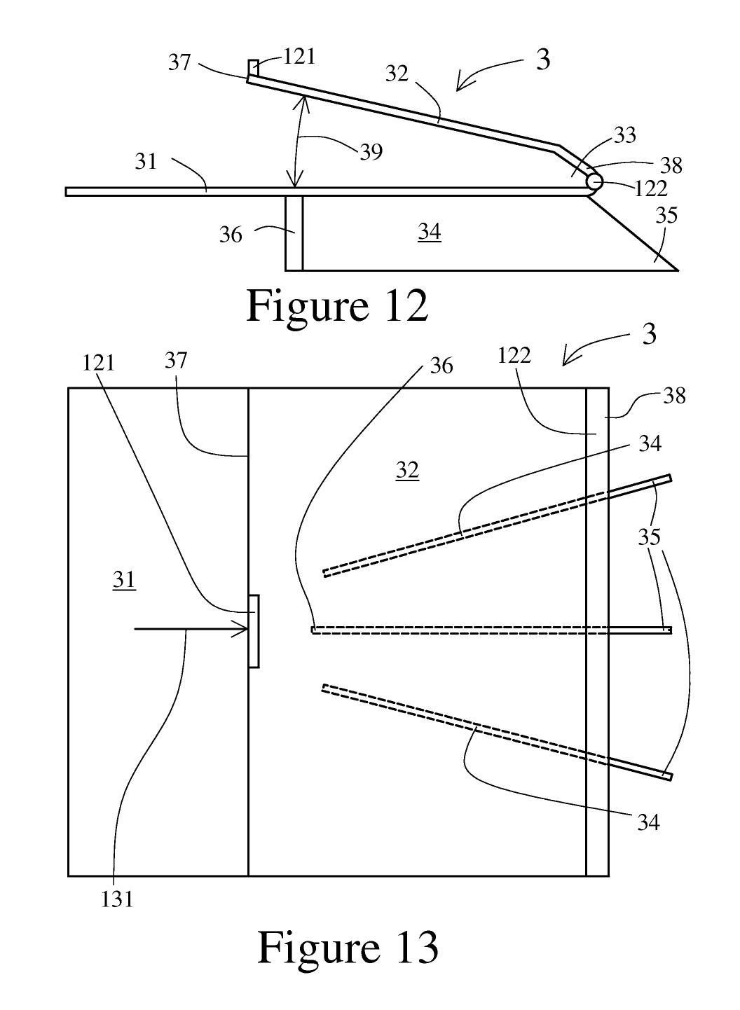

For this dislodging purpose, simply to provide additional surface area to apply an impulse to remove attachment(s) 3 from the rear extremity 1, FIG. 12 illustrates the embodiment of FIG. 3 with an optional attachment removal feature 121 integral with the rest of attachment 3 preferably proximate the forward extremity 37 of top planer surface 32 as shown, though it will also be appreciated that this can be sited at any convenient locale on top planer surface 32 of attachment 3 within the scope of this disclosure and the associated claims. FIG. 13 illustrates this same attachment removal feature 121 from a top plan view of attachment 3. With this optional attachment removal feature 121, the tow operator simply applies an impulse to optional attachment removal feature 121 along the removal impulse arrow 131 in FIG. 13. It will be appreciated by contrast to FIG. 7, that such a directed impulse applied proximate forward extremity 37 will serve to dislodge and separate attachment 3 from the rear extremity 1 of flatbed 14. Again, if optional attachment removal feature 121 is included, its exact locale can be varied within the scope of this disclosure and the associated claims in accordance with the functional objective of providing a convenient surface to strike attachment 3 to facilitate removal.

It is also to be understood within the scope of this disclosure and its associated claims that most commercial flatbeds comprise an acute rear extremity angle 23 referenced in FIG. 1 and that this angle as already noted is substantially the same from one flatbed to the next (approximately fifteen (15) degrees or slightly less). In this context, it is also understood that rear extremity angle 23 may vary for some particular flatbeds, and that the rear extremity 1 on certain flatbeds may even have a somewhat different shape. Because it is important to achieve a tight, stable mate between attachment 3 and the rear extremity 1 of flatbed 14, having the fixed mating angle 39 match up with the rear extremity angle 23 while also providing a mating clearance 33, it is to be understood that the present invention is not limited to the precise configurations illustrated here, but encompasses any variations in fixed mating angle 39 as well as the shape of attachment 3 at the top-to-bottom connection surface 38 as may be required to implement a tight mating of attachment 3 and the rear extremity 1 of flatbed 14. Thus, there may be a variety of traction-enhancing attachments 3 manufactured to mate properly with a parallel variety of flatbed rear extremities 1.

Finally, to accommodate any variations in flatbed configurations from one type or model of towing vehicle 12 to the next, FIGS. 12 and 13 each illustrate an optional locking hinge 122 for varying the fixed mating angle 39 between the top and bottom surfaces of traction-enhancing attachment 3. This locking hinge is schematically illustrated in FIGS. 12 and 13, with the understanding that there are a variety of known methods in the art that may be used to provide the require functionality, drawing from various hinge and pivot and locking designs used in a variety of pliars, wrenches and the like. Specifically, optional locking hinge 122 must have two functional characteristics: First, this hinge 122 needs to be capable of being unlocked so as to adjust fixed mating angle 39 to match up with substantial equivalence to the rear extremity angle 23 of the flatbed upon which attachment 3 is intended to be used. Second, once fixed mating angle 39 has been so-adjusted to the proper angular setting, hinge 122 needs to be capable of being locked so at fix the fabrication angle 39 at the angle to which the attachment 3 has been adjusted, and remaining locked when subjected to the large forces of winching. Again, this will enable a single traction-enhancing attachment 3 to be used for towing vehicles 12 with a variation in their flatbed rear extremities 1, rather than the user having to possess several traction-enhancing attachments 3 each with different fixed mating angles 39, one for each type of flatbed 14. This all means that the fixed mating angle 39 can be fixed on one of two ways: It can be permanently and unalterably fixed by the very fabrication of traction-enhancing attachment 3. Or, optionally and alternatively, it can be fixed by the use of optional locking hinge 122. Again, while most flatbeds are uniform with regard to their rear extremity angle 23, this discussion is meant to encompass the possibility that some flatbeds may vary from the norm, at present and/or in the future.

It will be appreciated from all of the foregoing disclosure that traction-enhancing attachment 3 does indeed add torque-balanced traction to a flatbed towing vehicle 12 in a manner that is safe, fast, simple, effective and inexpensive. This attachment 3 is safe, because the sprags 34, 36 used to effectuate the added traction are stowed whenever the tow vehicle 12 is driven on the road, and are only exposed when they are temporarily attached to the rear extremity 1 of the flatbed 14 to set up and perform a winching operation. There is no risk that somebody will be hurt by attachment 3 or its the sprag tips 35 so long as the tow operator behaves responsibly and removes attachment 3 when driving. And it also makes the winching safer because the added traction ensures that there will be no slippage or toppling of large vehicles during winching. It is fast and simple, because the tow operator simply places the attachment 3 on the flatbed rear extremity 1 and bangs it once or twice with a hammer or even by hand to secure it to the flatbed 14. This can all be carried out in a matter of a few seconds. From there, actuating the flatbed 14 into its mounting position and winching the disabled or immobilized vehicle onto the flatbed 14 proceeds in the customary manner without any variation. Once winching is completed, attachment 3 is removed with another bang or two and then stowed, also requiring at most a few seconds of time which is more than compensated by the added speed and safety with which a disabled or immobilized vehicle can be mounted for tow because of the improved traction provided by attachment 3.

The attachment 3 is effective because its use can be customized as and where needed in the professional judgment of the tow operator. The tow operator can decide in any situation where the best locales are to introduce enhanced traction and avoid torqueing, and can place the attachments 3 onto the flatbed 14 accordingly. When the operator determines that attachment 3 is not needed, it is not used. It is inexpensive, because it is simply fabricated from iron, steel or the like and purchased once. It is then can be used over and over again by the tow operator without limit and without any additional per-use costs.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. An attachment apparatus for enhancing traction during winching for a flatbed tow vehicle, comprising:
a top planar surface;
a bottom planar surface integrally-connected to said top planar surface at a fixed mating angle therebetween, wherein said fixed mating angle is substantially equal to a rear extremity angle between top and bottom surfaces of a rear extremity of a flatbed of the tow vehicle with which said apparatus is to be used; and
a plurality of sprags permanently affixed to an underside of said bottom planar surface.

2. The apparatus of claim 1, further comprising said plurality of sprags affixed to said underside of said bottom planar surface at a non-zero sprag radiation angle between adjacent sprags, such that said sprags radiate outwardly substantially from a common geometric point; whereby:
said radiating configuration when pressed backward against an underlying terrain during the winching enhances traction between the flatbed and the underlying terrain by wedging faces of said sprags against the underlying terrain.

3. The apparatus of claim 2, said plurality of sprags comprising three sprags.

4. The apparatus of claim 1, each of said sprags comprising:
a sprag tip at its rear extremity, angled at an acute angle;
a length from a front of said sprag to said sprag tip of 3 inches to 10 inches, inclusive;
said sprag length exceeding a sprag height by a factor from 2:1 to 8:1 inclusive; and
a sprag depth of ¼ inch to ½ inch inclusive whereby:
said acute angle of said sprag tip when pressed backward against an underlying terrain during the winching facilitates biting and penetration of said apparatus into the underlying terrain to establish enhanced traction between the flatbed and the underlying terrain.

5. The apparatus of claim 2, each of said sprags comprising:
a sprag tip at its rear extremity, angled at an acute angle;
a length from a front of said sprag to said sprag tip of 3 inches to 10 inches, inclusive;
said sprag length exceeding a sprag height by a factor from 2:1 to 8:1 inclusive; and
a sprag depth of ¼ inch to ½ inch inclusive whereby:
said acute angle of said sprag tip when pressed backward against an underlying terrain during the winching further facilitates biting and penetration of said apparatus into the underlying terrain to establish enhanced traction.

6. The apparatus of claim 2, said plurality of sprags further comprising at least two sprag sets, each sprag set comprising a plurality of sprags with a non-zero sprag radiation angle between adjacent sprags within said set, such that the sprags within said set radiate outwardly substantially from a common geometric point for said set; whereby:
said at least two sprag sets in said radiating configuration when pressed backward against an underlying terrain during the winching further enhances traction between the flatbed and the underlying terrain by wedging faces of said sprags against the underlying terrain.

7. The apparatus of claim 1, wherein said fixed mating angle between said bottom planar surface and said integrally-connected top planar surface is fixed by fabricating said apparatus such that said fixed mating angle is permanent and unalterable.

8. The apparatus of claim 1, further comprising a locking hinge between said bottom planar surface and said integrally-connected top planar surface, wherein said fixed mating angle between said bottom planar surface and said integrally-connected to said top planar surface is fixed by:
adjusting said hinge to a configuration in which the mating angle is substantially equal to the rear extremity angle of the flatbed; and
locking said hinge to fix said mating angle to be substantially equal to the rear extremity angle of the flatbed.

9. The apparatus of claim 1, said top planar surface further comprising an attachment removal feature for facilitating removal of said apparatus from the flatbed after said apparatus has been used.

10. The apparatus product of claim 1, produced by a process comprising:
unitarily fabricating said top planar surface and said a bottom planar surface integrally-connected thereto at said fixed mating angle therebetween as an integral article of manufacture; and
permanently affixing said plurality of sprags to said underside of said bottom planar surface using a welding process.

11. The apparatus product of claim 1, produced by a process comprising unitarily fabricating said top planar surface, said a bottom planar surface integrally-connected thereto and said plurality of sprags using a high-temperature molding process.

12. A method for enhancing traction between a flatbed tow vehicle and an underlying terrain during winching, comprising:
providing an attachment apparatus comprising: a top planar surface; a bottom planar surface integrally-connected to said top planar surface at a fixed mating angle therebetween, wherein said fixed mating angle is substantially equal to a rear extremity angle between top and bottom surfaces of a rear extremity of a flatbed of the flatbed tow vehicle; and a plurality of sprags permanently affixed to an underside of said bottom planar surface;
attaching said attachment to a rear extremity of the flatbed;
actuating the flatbed from a driving configuration to a mounting configuration by moving the flatbed rearward and concurrently tilting the flatbed downward in customary manner, but with said attachment attached, such that the rear extremity of the flatbed and thus the sprags affixed to said underside of said bottom planar surface of said attachment dig into and establish enhanced traction between said rear flatbed extremity and said underlying terrain so as to substantially bar said rear flatbed extremity from sliding backwards relative to said underlying terrain; and
winching a disabled and/or immobilized vehicle onto the tilted flatbed in customary manner, but with said sprags of said attachment dug into said underlying terrain providing additional traction at the locale where they are so-dug into the underlying terrain, to substantially bar said flatbed from sliding backwards relative to the underlying terrain during said winching.

13. The method of claim 12, further comprising:
enhancing traction between the flatbed and the underlying terrain by providing said plurality of sprags affixed to said underside of said bottom planar surface in a radiating configuration wherein said plurality of sprags comprise non-zero sprag radiation angle between adjacent sprags such that said sprags radiate outwardly substantially from a common geometric point, wherein:
when pressed backward against an underlying terrain during said winching, faces of said sprags wedge against the underlying terrain to enhance said traction at said locale where said sprags are dug into the underlying terrain.

14. The apparatus of claim 13, said plurality of sprags comprising three sprags.

15. The method of claim 12, further comprising:
facilitating biting and penetration of said attachment into the underlying terrain to establish enhanced traction between the flatbed and the underlying terrain by providing each said sprag with: a sprag tip at its rear extremity, angled at an acute angle; a length from a front of said sprag to said sprag tip of 3 inches to 10 inches, inclusive; said sprag length exceeding a sprag height by a factor from 2:1 to 8:1 inclusive; and a sprag depth of ¼ inch to ½ inch inclusive, wherein:
when pressed backward against an underlying terrain during said winching, said acute angles of said sprag tips facilitate said biting and penetration of said attachment into the underlying terrain to establish enhanced traction at said locale where said sprags are dug into the underlying terrain.

16. The method of claim 13, further comprising:
facilitating biting and penetration of said attachment into the underlying terrain to establish enhanced traction between the flatbed and the underlying terrain by providing each said sprag with: a sprag tip at its rear extremity, angled at an acute angle; a length from a front of said sprag to said sprag tip of 3 inches to 10 inches, inclusive; said sprag length exceeding a sprag height by a factor from 2:1 to 8:1 inclusive; and a sprag depth of ¼ inch to ½ inch inclusive, wherein:
when pressed backward against an underlying terrain during said winching, said acute angles of said sprag tips facilitate said biting and penetration of said attachment into the underlying terrain to establish enhanced traction at said locale where said sprags are dug into the underlying terrain.

17. The method of claim 13, said plurality of sprags further comprising at least two sprag sets, each sprag set comprising a plurality of sprags with a non-zero sprag radiation angle between adjacent sprags within said set, such that the sprags within said set radiate outwardly substantially from a common geometric point for said set, wherein:
when pressed backward against an underlying terrain during the winching, said at least two sprag sets in said radiating configuration further enhances traction between the flatbed and the underlying terrain by wedging faces of said sprags against the underlying terrain at said locale where said sprags are dug into the underlying terrain.

18. The method of claim 12, further comprising fixing said fixed mating angle between said bottom planar surface and said integrally-connected top planar surface by fabricating said attachment such that said fixed mating angle is permanent and unalterable.

19. The method of claim 12, further comprising fixing said fixed mating angle between said bottom planar surface and said integrally-connected to said top planar surface by:
adjusting a locking hinge between said bottom planar surface and said integrally-connected top planar surface to a configuration in which the mating angle is substantially equal to the rear extremity angle of the flatbed; and
locking said hinge to fix said mating angle to be substantially equal to the rear extremity angle of the flatbed.

20. The method of claim 12, further comprising removing of said attachment from the flatbed after said attachment has been used, via an attachment removal feature for facilitating said removing.

21. The method of claim 12, further comprising attaching said attachment to the rear extremity of the flatbed so as to be substantially-centered along the rear extremity.

22. The method of claim 12, further comprising attaching additional, like-attachments, to the rear extremity of the flatbed.
